(19) United States
(12) Patent Application Publication
(10) Pub. No.: US 2019/0085705 A1
(43) Pub. Date: Mar. 21, 2019

(54) COMPONENT FOR A TURBINE ENGINE WITH A FILM-HOLE

(71) Applicant: General Electric Company, Schenectady, NY (US)

(72) Inventors: Zachary Daniel Webster, Mason, OH (US); Daniel Scott Martyn, Mason, OH (US); Aaron Ezekiel Smith, Hermosa Beach, CA (US); Kirk D. Gallier, Cincinnati, OH (US)

(21) Appl. No.: 15/707,303

(22) Filed: Sep. 18, 2017

(51) Int. Cl. F01D 5/18; F01D 9/02; F01D 25/12

(52) U.S. Cl. CPC F01D 5/186; F01D 9/02; F01D 25/12; F05D 2260/2214; F05D 2240/35; F05D 2240/14; F05D 2230/90

(57) ABSTRACT

An apparatus and method relating to a film-hole of a component of a turbine engine. The film-hole can extend from an inlet to an outlet to define a passage. The film-hole can include a laid back section where a coating can be applied. The method can include forming the film-hole in the component and applying the coating to the component to maintain a specific geometry.

### BACKGROUND OF THE INVENTION

Turbine engines, and particularly gas or combustion turbine engines, are rotary engines that extract energy from a flow of combusted gases passing through the engine onto a multitude of rotating turbine blades.

Engine efficiency increases with temperature of combustion gases. However, the combustion gases heat the various components along their flow path, which in turn requires cooling thereof to achieve a long engine lifetime. Typically, the hot gas path components are cooled by bleeding air from the compressor. This cooling process reduces engine efficiency, as the bled air is not used in the combustion process.

Turbine engine cooling art is mature and includes numerous patents for various aspects of cooling circuits and features in the various hot gas path components. For example, the combustor includes radially outer and inner liners, which require cooling during operation. Turbine nozzles include hollow vanes supported between outer and inner bands, which also require cooling. Turbine rotor blades are hollow and typically include cooling circuits therein, with the blades being surrounded by turbine shrouds, which also require cooling. The hot combustion gases are discharged through an exhaust which may also be lined, and suitably cooled.

In all of these exemplary turbine engine components, thin metal walls of high strength superalloy metals are typically used for enhanced durability while minimizing the need for cooling thereof. Various cooling circuits and features are tailored for these individual components in their corresponding environments in the engine. In addition, all of these components typically include common rows of film cooling holes.

A typical film cooling hole is a cylindrical bore for discharging a film of cooling air along the external surface of the wall to provide thermal insulation against the flow from hot combustion gases during operation. A coating, for example a thermal barrier coating, can be applied to portions of the film-hole to prevent damage. The coating can contribute to an undesirable stream away from the heated wall rather than along the heated wall, which can lead to flow separation and a loss of the film cooling effectiveness. The geometrical relationship between the coating and the film-hole can affect engine efficiency and airfoil cooling.

### BRIEF DESCRIPTION OF THE INVENTION

In one aspect the disclosure relates to a component for a turbine engine, which generates a hot gas flow, and provides a cooling fluid flow, comprising a wall separating the hot gas flow from the cooling fluid flow and having a hot surface along which the hot gas flows and a cool surface facing the cooling fluid flow. The engine component includes at least one film-hole having an inlet on the cool surface and an outlet on the hot surface with a passage extending from the inlet to the outlet, a coating applied to at least a portion of the passage including the outlet and extending beyond the outlet along the hot surface, and a diffusing section defined by the passage and the coating and having an increasing cross-sectional area extending at least to the outlet.

In another aspect the disclosure relates to an airfoil for a turbine engine, which generates a hot gas flow, and provides a cooling fluid flow, comprising a wall separating the hot gas flow from the cooling fluid flow and having a hot surface along which the hot gas flows and a cool surface facing the cooling fluid flow. The airfoil includes at least one film-hole having an inlet on the cool surface and an outlet on the hot surface with a passage extending from the inlet to the outlet, a coating applied to at least a portion of the passage including the outlet and extending beyond the outlet along the hot surface, and a diffusing section defined by the passage and the coating and having an increasing cross-sectional area extending at least to the outlet.

In yet another aspect, the disclosure relates to a method of forming a film-hole having an inlet and an outlet and connected by a passage extending from the inlet to the outlet for an engine component, the method comprising applying a coating along a portion of the passage, forming a diffusing section defining the outlet and having an increasing cross-sectional area such that a portion of the diffusing section is defined by the coating.

### BRIEF DESCRIPTION OF THE DRAWINGS

In the drawings:

FIG. 1 is a schematic cross-sectional diagram of a turbine engine for an aircraft.

FIG. 2 is an isometric view of an exemplary airfoil for the turbine engine of FIG. 1.

FIG. 3 is a cross-sectional view of the airfoil of FIG. 2 along line III-III.

FIG. 4 is an enlarged view of a film-hole for the airfoil of FIG. 3.

FIG. 5 is the enlarged view of the film-hole of FIG. 4 with an added coating according to an aspect of the disclosure described herein.

FIG. 6 is a view of the film-hole from FIG. 5 as can be seen from an outlet of the film-hole towards and inlet of the film-hole.

FIG. 7 is a graph illustrating a thickness of the coating applied in FIG. 6 with respect to a cross-section taken along line VII-VII in FIG. 5.

FIG. 8 is a graph illustrating a thickness of the coating applied in FIG. 6 with respect to a cross-section taken along line VIII-VIII in FIG. 5.

FIG. 9 is the enlarged view of FIG. 5 illustrating a path along which cooling fluid can flow through the film-hole.

### DESCRIPTION OF EMBODIMENTS OF THE INVENTION

Aspects of the disclosure described herein are directed to the formation of a hole such as a film-hole in an engine component such as an airfoil. For purposes of illustration, the aspects of the disclosure discussed herein will be described with respect to the turbine for an aircraft turbine engine. It will be understood, however, that the disclosure as discussed herein is not so limited and may have general applicability within an engine, including compressors, as well as in non-aircraft applications, such as other mobile applications and non-mobile industrial, commercial, and residential applications.

As used herein, the term “forward” or “upstream” refers to moving in a direction toward the engine inlet, or a component being relatively closer to the engine inlet as compared to another component. The term “aft” or “downstream” used in conjunction with “forward” or “upstream” refers to a direction toward the rear or outlet of the engine relative to the engine centerline. Additionally, as used herein, the terms “radial” or “radially” refer to a dimension extending between a center longitudinal axis of the engine and an outer engine circumference. Furthermore, as used herein, the term “set” or a “set” of elements can be any number of elements, including only one.

All directional references (e.g., radial, axial, proximal, distal, upper, lower, upward, downward, left, right, lateral, front, back, top, bottom, above, below, vertical, horizontal, clockwise, counterclockwise, upstream, downstream, aft, etc.) are only used for identification purposes to aid the reader's understanding of the present disclosure, and do not create limitations, particularly as to the position, orientation, or use of the disclosure. Connection references (e.g., attached, coupled, connected, and joined) are to be construed broadly and can include intermediate members between a collection of elements and relative movement between elements unless otherwise indicated. As such, connection references do not necessarily infer that two elements are directly connected and in fixed relation to one another. Furthermore it should be understood that the term cross section or cross-sectional as used herein is referring to a section taken orthogonal to the centerline and to the general coolant flow direction in the hole. The exemplary drawings are for purposes of illustration only and the dimensions, positions, order and relative sizes reflected in the drawings attached hereto can vary.

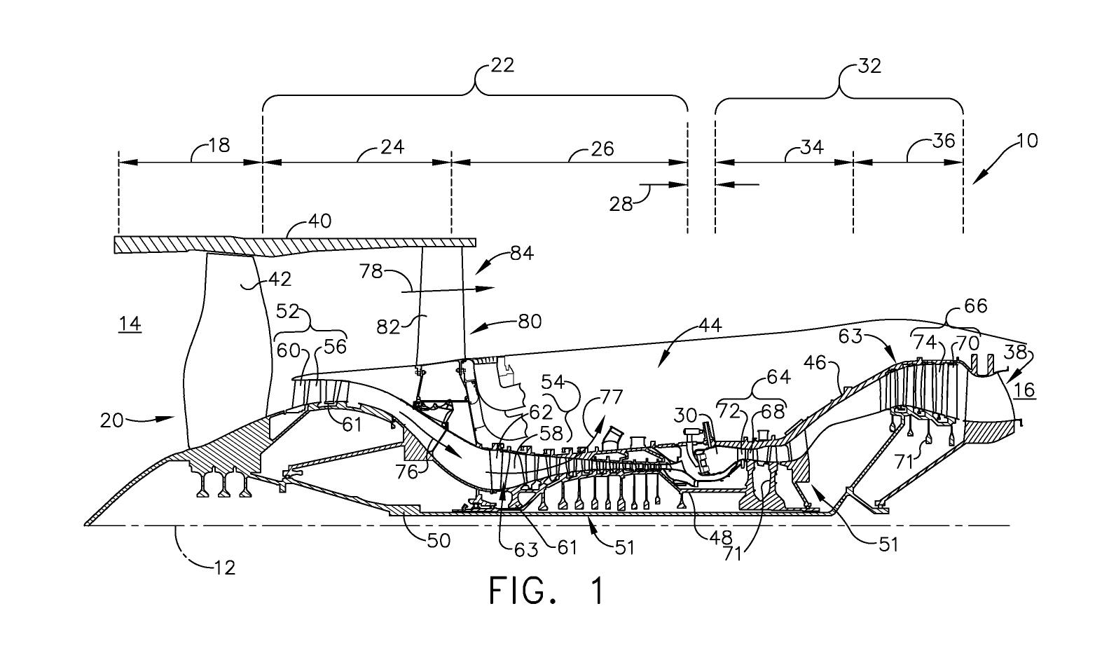

Referring to FIG. 1, an engine 10 has a generally longitudinally extending axis or centerline 12 extending forward 14 to aft 16. The engine 10 includes, in downstream serial flow relationship, a fan section 18 including a fan 20, a compressor section 22 including a booster or low pressure (LP) compressor 24 and a high pressure (HP) compressor 26, a combustion section 28 including a combustor 30, a turbine section 32 including a HP turbine 34, and a LP turbine 36, and an exhaust section 38.

The fan section 18 includes a fan casing 40 surrounding the fan 20. The fan 20 includes a plurality of fan blades 42 disposed radially about the centerline 12. The HP compressor 26, the combustor 30, and the HP turbine 34 form a core 44 of the engine 10, which generates combustion gases. The core 44 is surrounded by core casing 46, which can be coupled with the fan casing 40.

A HP shaft or spool 48 disposed coaxially about the centerline 12 of the engine 10 drivingly connects the HP turbine 34 to the HP compressor 26. A LP shaft or spool 50, which is disposed coaxially about the centerline 12 of the engine 10 within the larger diameter annular HP spool 48, drivingly connects the LP turbine 36 to the LP compressor 24 and fan 20. The spools 48, 50 are rotatable about the engine centerline and couple to a plurality of rotatable elements, which can collectively define a rotor 51.

The LP compressor 24 and the HP compressor 26 respectively include a plurality of compressor stages 52, 54, in which a set of compressor blades 56, 58 rotate relative to a corresponding set of static compressor vanes 60, 62 (also called a nozzle) to compress or pressurize the stream of fluid passing through the stage. In a single compressor stage 52, 54, multiple compressor blades 56, 58 can be provided in a ring and can extend radially outwardly relative to the centerline 12, from a blade platform to a blade tip, while the corresponding static compressor vanes 60, 62 are positioned upstream of and adjacent to the rotating blades 56, 58. It is noted that the number of blades, vanes, and compressor stages shown in FIG. 1 were selected for illustrative purposes only, and that other numbers are possible.

The blades 56, 58 for a stage of the compressor mount to a disk 61, which mounts to the corresponding one of the HP and LP spools 48, 50, with each stage having its own disk 61. The vanes 60, 62 for a stage of the compressor mount to the core casing 46 in a circumferential arrangement.

The HP turbine 34 and the LP turbine 36 respectively include a plurality of turbine stages 64, 66, in which a set of turbine blades 68, 70 are rotated relative to a corresponding set of static turbine vanes 72, 74 (also called a nozzle) to extract energy from the stream of fluid passing through the stage. In a single turbine stage 64, 66, multiple turbine blades 68, 70 can be provided in a ring and can extend radially outwardly relative to the centerline 12, from a blade platform to a blade tip, while the corresponding static turbine vanes 72, 74 are positioned upstream of and adjacent to the rotating blades 68, 70. It is noted that the number of blades, vanes, and turbine stages shown in FIG. 1 were selected for illustrative purposes only, and that other numbers are possible.

The blades 68, 70 for a stage of the turbine can mount to a disk 71, which is mounts to the corresponding one of the HP and LP spools 48, 50, with each stage having a dedicated disk 71. The vanes 72, 74 for a stage of the compressor can mount to the core casing 46 in a circumferential arrangement.

Complementary to the rotor portion, the stationary portions of the engine 10, such as the static vanes 60, 62, 72, 74 among the compressor and turbine section 22, 32 are also referred to individually or collectively as a stator 63. As such, the stator 63 can refer to the combination of non-rotating elements throughout the engine 10.

In operation, the airflow exiting the fan section 18 splits such that a portion of the airflow is channeled into the LP compressor 24, which then supplies pressurized air 76 to the HP compressor 26, which further pressurizes the air. The pressurized air 76 from the HP compressor 26 mixes with fuel in the combustor 30 where the fuel combusts, thereby generating combustion gases. The HP turbine 34 extracts some work from these gases, which drives the HP compressor 26. The HP turbine 34 discharges the combustion gases into the LP turbine 36, which extracts additional work to drive the LP compressor 24, and the exhaust gas is ultimately discharged from the engine 10 via the exhaust section 38. The driving of the LP turbine 36 drives the LP spool 50 to rotate the fan 20 and the LP compressor 24.

A portion of the pressurized airflow 76 can be drawn from the compressor section 22 as bleed air 77. The bleed air 77 can be drawn from the pressurized airflow 76 and provided to engine components requiring cooling. The temperature of pressurized airflow 76 entering the combustor 30 is significantly increased. As such, cooling provided by the bleed air 77 is necessary for operating of such engine components in the heightened temperature environments.

A remaining portion of the airflow 78 bypasses the LP compressor 24 and engine core 44 and exits the engine assembly 10 through a stationary vane row, and more particularly an outlet guide vane assembly 80, comprising a plurality of airfoil guide vanes 82, at the fan exhaust side 84. More specifically, a circumferential row of radially extending airfoil guide vanes 82 are utilized adjacent the fan section 18 to exert some directional control of the airflow 78.

Some of the air supplied by the fan 20 can bypass the engine core 44 and be used for cooling of portions, especially hot portions, of the engine 10, and/or used to cool or power other aspects of the aircraft. In the context of a turbine engine, the hot portions of the engine are normally downstream of the combustor 30, especially the turbine section 32, with the HP turbine 34 being the hottest portion as it is directly downstream of the combustion section 28. Other sources of cooling fluid can be, but are not limited to, fluid discharged from the LP compressor 24 or the HP compressor 26.

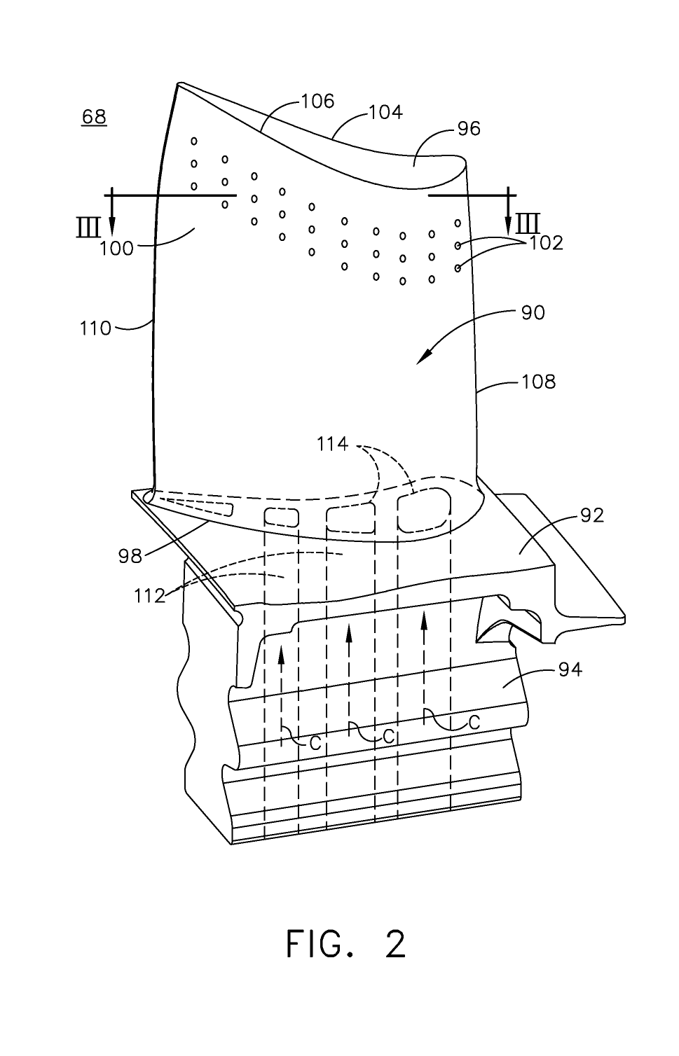

FIG. 2 is a perspective view of an example of an engine component illustrated as an airfoil 90, a platform 92, and a dovetail 94, which can be a rotating blade 68, as shown in FIG. 1. Alternatively, it is contemplated that the airfoil 90 can be a stationary vane, such as the vane 72 of FIG. 1, while any suitable engine component is contemplated. The airfoil 90 includes a tip 96 and a root 98, defining a span-wise direction there between. Additionally, the airfoil 90 includes a wall 100. A pressure side 104 and a suction side 106 are defined by the airfoil shape of the wall 100. At least one film-hole 102 is formed in the wall 100. The at least one film-hole 102 can be multiple film-holes 102 as illustrated, and, by way of non-limiting example, can be located along the suction side 106 of the airfoil 90. The airfoil 90 further includes a leading edge 108 and a trailing edge 110, defining a chord-wise direction.

The airfoil 90 mounts to the platform 92 at the root 98. The platform 92 is shown in section, but can be formed as an annular band for mounting a plurality of airfoils 90. The airfoil 90 can fasten to the platform 92, such as welding or mechanical fastening, or can be integral with the platform 92 in non-limiting examples.

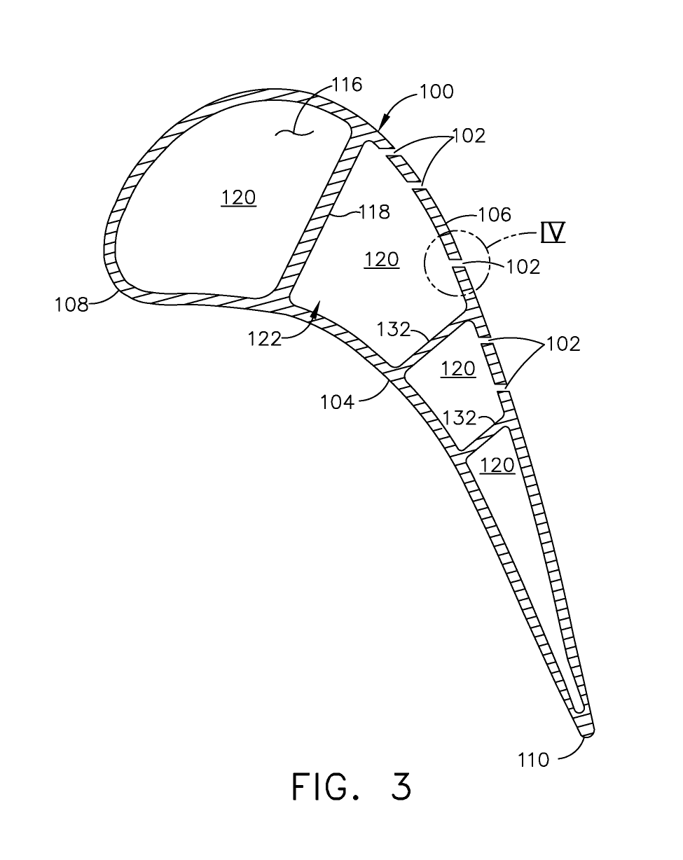

The dovetail 94 couples to the platform 92 opposite of the airfoil 90, and can be configured to mount to the disk 71, or rotor 51 of the engine 10 (FIG. 1), for example. In one alternative example, the platform 92 can be formed as part of the dovetail 94. The dovetail 94 can include one or more inlet passages 112, having an outlet 114 disposed at the root 98. The inlet passages 112 can provide a cooling fluid flow (C) to an interior 116 (FIG. 3) of the airfoil 90 at the outlet 114 for cooling of the airfoil 90 in one non-limiting example.

It should be understood that while the description herein is related to an airfoil, it can have equal applicability in other engine components requiring cooling such as film cooling. One or more of the engine components of the engine 10 includes a film-cooled substrate, or wall, in which a film cooling hole, or hole, of the disclosure further herein may be provided. Some non-limiting examples of the engine component having a wall can include blades, vanes or nozzles, a combustor deflector, combustor liner, or a shroud assembly. Other non-limiting examples where film cooling is used include turbine transition ducts and exhaust nozzles.

During operation, the airfoil 90 rotates in a direction such that the pressure side 104 follows the suction side 106, such that the airfoil 90 would rotate in a direction out of the page.

Referring now to FIG. 3, an interior 116 is defined by the outer wall 100. One or more interior walls shown as ribs 118 can divide the interior 116 into multiple cooling passages 120. Each of the passage outlets 114 of FIG. 2 can be fluidly coupled to one or more internal cooling passages 120. One or more of the inlet passages 112, passage outlets 114, internal cooling passages 120, and film-holes 102, can be fluidly coupled to each other and at least partially form one or more cooling circuits 122 within the airfoil 90. At least one of the cooling passages 120 is in fluid communication with the film-holes 102.

It should be appreciated that the interior structure of the airfoil 90 is exemplary as illustrated. The interior 116 of the airfoil 90 can be organized in a myriad of different ways, and the cooling passages 120 can include single passages extending in the span-wise direction, or can be complex cooling circuits, having multiple features such as passages, channels, inlets, outlets, ribs, pin banks, circuits, sub-circuits, film-holes, plenums, mesh, turbulators, or otherwise in non-limiting examples.

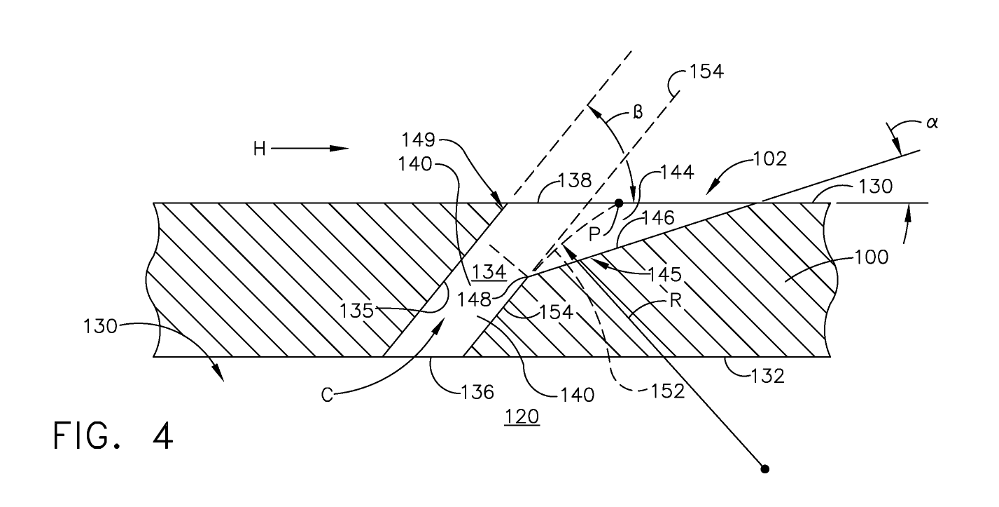

FIG. 4 is a schematic, sectional view of one of the film-holes 102 extending through the wall 100 of the airfoil 90. The wall 100 includes a hot surface 130 facing a hot gas flow (H) and a cool surface 132 facing a cooling fluid (C). In one non-limiting example, the cool surface 132 can form a portion of the cooling passage 120 and the hot surface can form a portion of the exterior of the wall 100. Suitable materials for the wall 100 include, but are not limited to, steel, refractory metals such as titanium, or superalloys based on nickel, cobalt, or iron, and ceramic matrix composites. The superalloys can include those in equi-axed, directionally solidified, and single crystal structures, for example.

It is noted that although the wall 100 is shown as being generally planar in FIG. 4, it should be understood that that the wall 100 can be curved for many engine components. Whether the wall 100 is planar or curved local to the film-hole 102, the hot and cool surfaces 130, 132 can be parallel to each other as shown herein, or can lie in non-parallel planes.

The film-hole 102 provides fluid communication between the interior 116 and exterior of the airfoil 90. During operation, the cooling fluid flow (C) is supplied to the interior 116, such as the cooling passage 120, and exhausts from the film-hole 102 as a thin layer or film of cool air along the hot surface 130. While only one film-hole 102 is shown in FIG. 3, it is understood that the airfoil 90 can include multiple film-holes 102, which can be arranged in any desired configuration along the wall 100.

An inlet 136 for the film-hole is provided on the cool surface 132 and an outlet 138 is provided on the hot surface 130. A passage 134 including an interior surface 135 extends between the inlet 136 and the outlet 138 and can at least partially define the film-hole 102.

A laid back section 144 can be provided at or near the outlet 138 to define at least a portion of the passage 134 such that the film-hole 102 has a laidback hole shape. The laid back section can terminate at the outlet 138. The laid back section 144 can have an increasing cross-sectional area extending toward the outlet 138, where in some implementations the cross-sectional area is continuously increasing as illustrated. In one alternative, non-limiting implementation, the increasing cross-sectional area can be discrete.

The passage 134 can further include a metering section 140 having a circular cross section, though it could have any cross-sectional shape. The metering section 140 can be provided at or near the inlet 136, and upstream of the laid back section 144 with respect to the direction of cooling fluid flow (C) through the passage 134. The metering section 140 can terminate at the laid back section 144, defining a junction 148. The interior surface 135 at the outlet 138 can form an angle β with the hot surface 130.

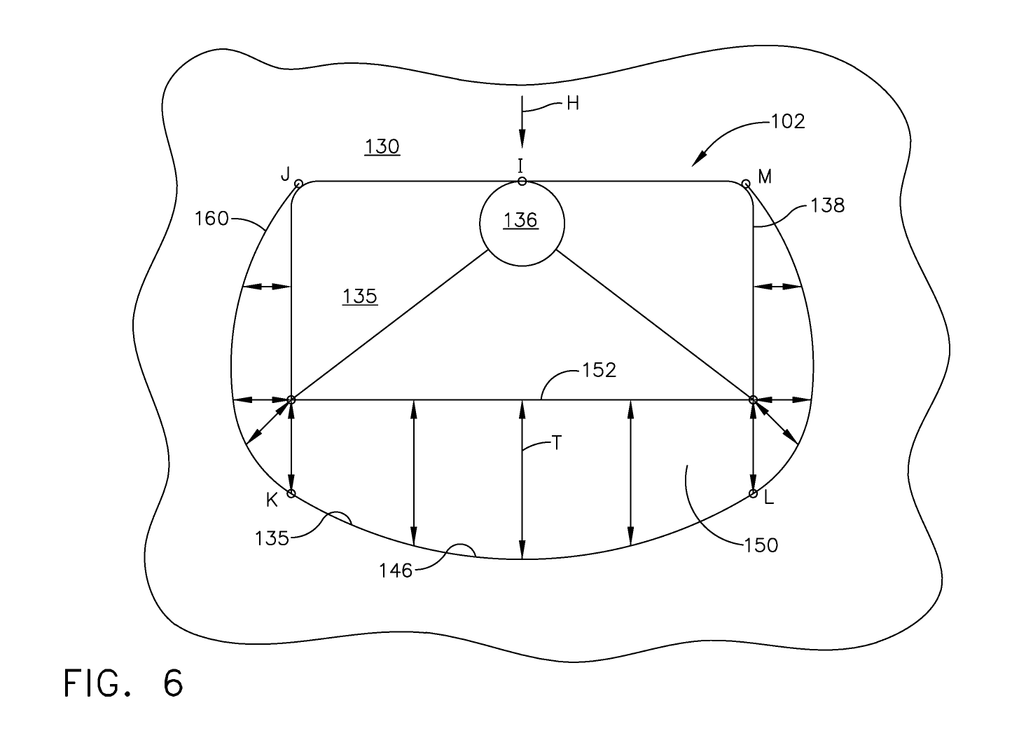

An angled surface 146 can extend from the junction 148 to the outlet 138 along the laid back section 144. The angled surface 146 can be a curved surface when viewed in cross-section (FIG. 6). The angled surface 146 forms an angle α with respect to the hot surface 130 that can be less than the angle β, for example.

A surface line 154 can be defined along the downstream edge of the interior surface 135 within the metering section 140, relative to the hot gas flow (H). A border line 152 illustrated in dashed line extends along a radius of curvature (R) that tangentially intersects the surface line 154 at the junction 148. The border line 152 intersects the outlet 138 at point (P) downstream from where the surface line 154 intersects the outlet 138. The radius of curvature (R) can vary within the area downstream of the surface line 154 and is dependent upon the amount of turn over which the cooling fluid (C) must travel in order to provide a film of cooling fluid (C) along the hot surface 130. A coating area 145 can be defined as the volume enclosed by the angled surface 146, the junction 148, the border line 152, and the outlet 138 downstream of the point (P).

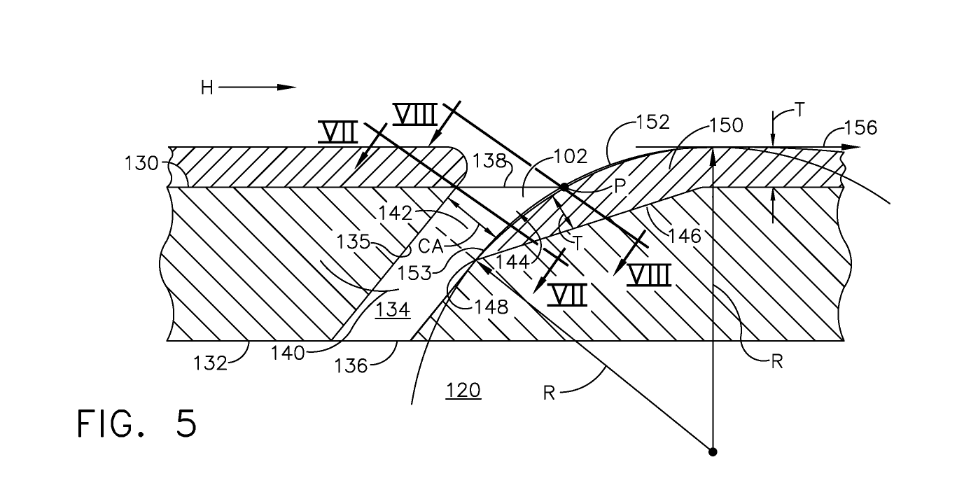

Turning to FIG. 5, a coating 150, such as a thermal barrier coating in one non-limiting example, is provided within the coating area 145. The coating 150 can be provided from the junction 148 and extend exterior of the outlet 138. The coating 150 includes a thickness (T) from the angled surface 146 to the border line 152. The thickness (T) of the coating 150 can increase from the junction 148 towards the outlet 138 such that the thickness (T) changes within the coating area 145 while following the border line 152 along the radius of curvature (R). Once the coating 150 reaches the hot surface 130, the thickness (T) can remain constant along the hot surface 130. The thickness (T) at which the coating 150 is maintained along the hot surface 130 can be defined as a distance from the hot surface 130 to a line 156 parallel to the hot surface 130 that tangentially intersects with the radius of curvature (R). The coating 150 can be applied on all portions of the hot surface 130 as illustrated. It should be understood that the coating as applied can have a varying thickness (T) or a constant thickness (T) and is not limited to either.

A diffusing section 142 is any remaining portion of the laid back section 144 that remains free from the coating 150 and is defined, at least in part, by the coating 150. In this manner the passage 134 is defined at least in part by the material from which the wall 100 is formed, by way of non-limiting example a metal, and in part by the coating 150. The diffusing section 142 can have an increasing cross-sectional area (CA) extending toward the outlet 138 and measured from an outer surface 153 of the coating 150 to the interior surface 135 of the film-hole 102 opposite the outer surface 153. In some implementations the cross-sectional area (CA) is continuously increasing as illustrated.

The passage 134 is a connecting passage between the inlet 136 and the outlet 138 through which the cooling fluid (C) can flow. The metering section is for metering of the mass flow rate of the cooling fluid flow (C). The diffusing section enables an expansion of the cooling fluid (C) to form a wider and slower cooling film on the hot surface 130. The diffusing section 142 can be in serial flow communication with the metering section 140. It is alternatively contemplated that the film-hole 102 have a minimal or no metering section 140, or that the diffusing section 142 extends along the entirety of the film-hole 102.

A view of the film-hole 102 looking at the outlet 138 toward the inlet 136 is illustrated in FIG. 6. While illustrated as a rounded rectangular outlet, the shape of the outlet 138 as illustrated is not meant to be limiting and the outlet 138 can define any shape, including but not limited to circular, oblong, oval, and square. The coating 150 has a variable thickness (T) along the interior surface 135. The coating 150 as depicted is for illustrative purposes only and it should be understood that the coating can also define various shapes in cross-section. A perimeter 160 of the outlet 138 at the hot surface 130 extends from point I to J to K to L to M and back to I. As illustrated, when travelling along the perimeter, the thickness (T) of the coating 150 changes from no coating between points I and J to a coating of (T) thickness between points K and L.

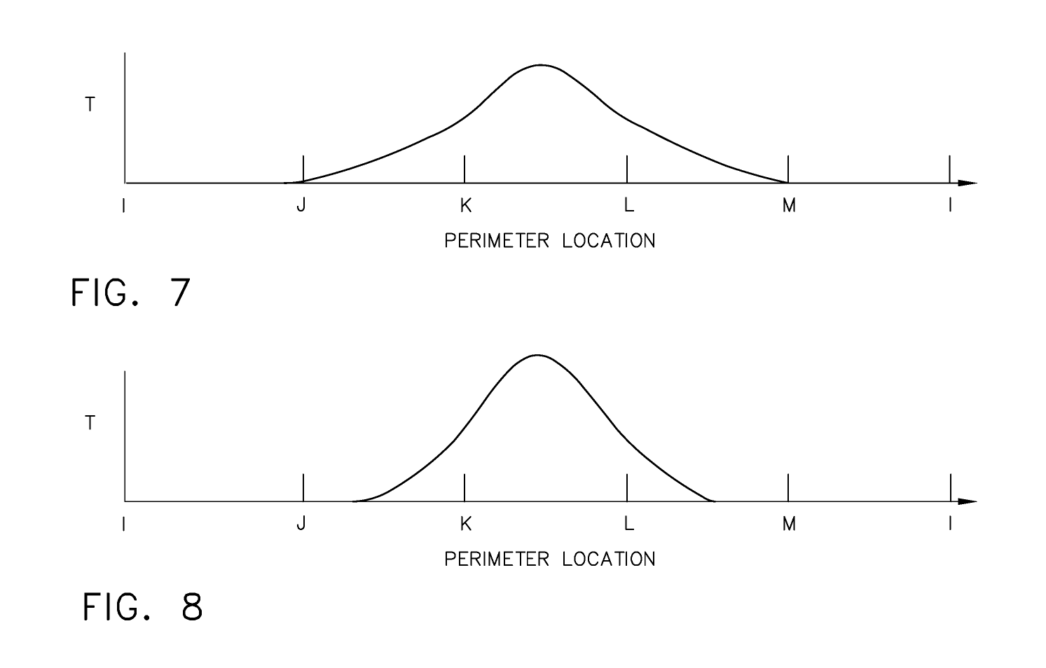

To more clearly explain the geometry of the coating 150, FIG. 7 is a first graph illustrating how the thickness (T) changes along the perimeter 160 of the outlet 138 for a cross-section taken along line VII-VII in FIG. 5. The cross-section would look very similar to FIG. 6. As can be seen in the graph, when traveling from point I to point J, no coating is present on the interior surface 135. Moving along the perimeter 160 from point J to point K an amount of coating 150 with increasing thickness is present on the interior surface 135. Between points K and L the thickness (T) of the coating 150 peaks. Moving back towards I from L to M to I, the thickness (T) of the coating 150 gradually decreases along the interior surface 135 at the same rate it increased from I to J to K to L. While depicted as increasing and decreasing at the same rate, it is contemplated that the amount of coating along the interior surface can increase and decrease at different rates whilst maintaining the aforementioned radius of curvature (R).

The amount of coating 150 applied to the angled surface 146 changes in order to maintain the radius of curvature (R) as illustrated in FIG. 5. Therefore a second graph illustrated in FIG. 8 depicts how the thickness (T) changes along the perimeter 160 for a cross-section taken along line VIII-VIII in FIG. 5. Again much like the thickness (T) changes discussed with reference to FIG. 7, when traveling around the perimeter 160, the thickness (T) of the coating 150 changes. Because the second graph represents a change for a cross-section close to the outlet 138, the amount of coating 150 is greater between points I and J than in the first graph. The amount of coating 150 increased when moving from the junction 148 to the outlet 138 to maintain the radius of curvature (R).

A method of forming the film-hole 102 includes forming the diffusing section 142 with an increasing cross-sectional area (CA) and applying the coating 150 along a portion of the passage 134 such that a portion of the diffusing section 142 is defined by the coating 150. Forming of the film-hole 102 can be done in any suitable manner including but not limited to casting, additive manufacturing, drilling, or electrical discharge machining with a laser. A two-step drilling process utilizing any of the aforementioned suitable manners can also be utilized where the passage 134 is drilled and then the laid back section is formed after which the coating 150 is placed to form the diffusing section 142. It should be understood that any suitable method for forming the film-hole 102 is contemplated and that manners discussed herein are for illustrative purposes and not meant to be limiting.

The method can include forming the metering section 140 extending from the inlet 136 to the diffusing section 142. It is further contemplated that where the metering section 140 meets the diffusing section defines the junction 148 as described herein. However, the junction 148 can be located at one end of the diffusing section 142 opposite the outlet 138, by way of non-limiting example at the inlet 136 for a film-hole 102 formed without a metering section 140. Further, applying coating can include applying the coating 150 to extend from the junction 148 towards the outlet 138. Extending the coating 150 from the junction 148 towards the outlet 138 can be done such that the outer surface 153 of the coating 150 is located at the radius of curvature (R). The coating can extend beyond the outlet 138 along the hot surface 130. The radius of curvature (R) can be maintained beyond the outlet 138 as well such that the method can include applying a coating 150 having a varying thickness (T). The coating 150 is applied along the hot surface (H) while maintaining the radius of curvature (R).

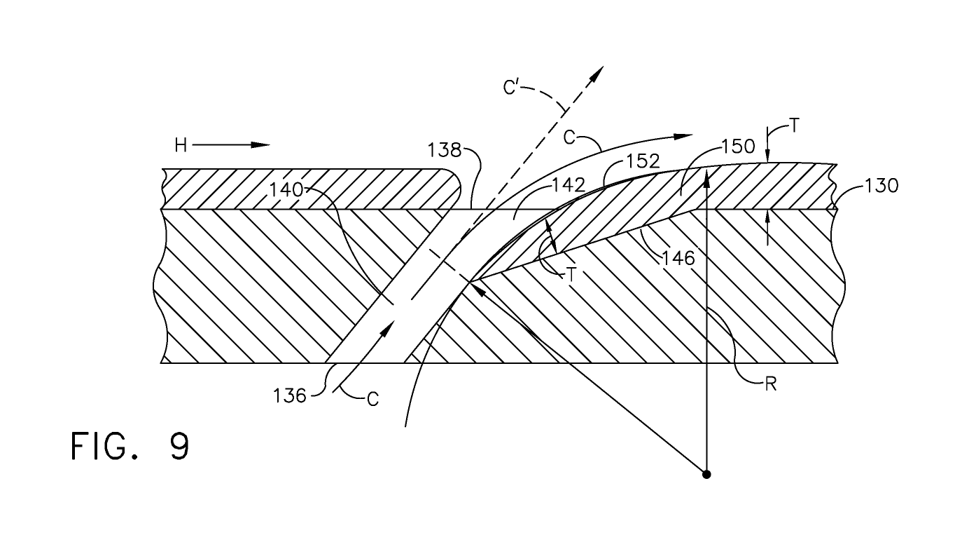

To better understand the benefit of placing the coating 150 with a varying thickness (T) FIG. 9 illustrates cooling the hot surface 130 by utilizing the coating 150. Increasing the thickness (T) of the coating 150 until reaching the hot surface 130 enables the cooling fluid (C) to turn gradually hugging the coating 150 to form a film for cooling the hot surface 130 and prevents cooling fluid (C) from streaming straight out into the hot gas flow (H) illustrated by dashed line (C′). Such a curvature for the coating 150 can provide improved attachment for the flow of cooling fluid (C) exhausting along the coating 150, which can improve film effectiveness. It should be understood that the coating 150 can taper down to meet the hot surface 130 and need not abruptly end as shown in FIG. 9. Depending on the engine component for which the film-hole is being used, different geometries of the coating at the hot surface 130 can be contemplated. In one example, the taper can be tailored to minimize detachment of the hot gas flow (H) generated by a portion of the coating 150 extending into the flow.

Benefits associated with maintaining the radius of curvature for the coating include decreasing jet penetration into the mainstream of the hot gas flow and increasing the cooling effectiveness of the cooling fluid along the hot surface. Implementations where the coating commences at the junction enables a smooth transition from within the film-hole toward the hot surface. Cooling fluid is directed at to gradually turn towards the hot surface 130 rather than stream straight out of the film-hole.

Technical benefits associated with the disclosure as described herein include increasing a cooling effectiveness to help hot gas path components meet durability.

Turbine cooling is important in next generation architecture which includes ever increasing temperatures. Current cooling technology needs to expand to the continued increase in core temperature of the engine that comes with more efficient engine design. Optimizing cooling at the surface of engine components by shaping the outlet surface to improve film coverage is beneficial to the entire engine. The engine component as described herein would yield a better film coverage on the hot surfaces. This geometry enables thermal performance and improved durability and engine fuel burn.

It should be appreciated that application of the disclosed design is not limited to turbine engines with fan and booster sections, but is applicable to turbojets and turbo engines as well.

This written description uses examples to illustrate the disclosure as discussed herein, including the best mode, and also to enable any person skilled in the art to practice the disclosure as discussed herein, including making and using any devices or systems and performing any incorporated methods. The patentable scope of the disclosure as discussed herein is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

What is claimed is:

1. A component for a turbine engine, which generates a hot gas flow, and provides a cooling fluid flow, comprising:
a wall separating the hot gas flow from the cooling fluid flow and having a hot surface along which the hot gas flows and a cool surface facing the cooling fluid flow;
at least one film-hole having an inlet on the cool surface and an outlet on the hot surface with a passage extending from the inlet to the outlet;
a coating bound by a radius of curvature and applied to at least a portion of the passage including the outlet and extending beyond the outlet along the hot surface; and
a diffusing section defined by the passage and the coating and having an increasing cross-sectional area extending at least to the outlet.

2. The component of claim 1 wherein the increasing cross-sectional area is continuously increasing.

3. The component of claim 1 wherein the at least one film-hole further includes a laid back section having an increasing cross-sectional area where the coating is provided in a portion of the laid back section to define the diffusing section.

4. The component of claim 1 wherein the film-hole comprises a metering section located upstream of the diffusing section.

5. The component of claim 4 wherein the metering section is located in at least one of the passage or the inlet.

6. The component of claim 1 wherein the diffusing section extends only partially along the passage and forms a junction at an end of the diffusing section opposite of the outlet.

7. The component of claim 6 wherein the coating extends from the junction to the outlet.

8. The component of claim 7 wherein the passage defines a surface line that tangentially intersects the radius of curvature at the junction.

9. The component of claim 1 wherein the coating is further bound by a border line extending along the radius of curvature.

10. The component of claim 1 wherein the coating has a varying thickness.

11. The component of claim 1 wherein the passage includes an interior surface defined in part by the film-hole and in part by the coating.

12. The component of claim 1 wherein the coating extending along the hot surface maintains a constant thickness.

13. An airfoil for a turbine engine, which generates a hot gas flow, and provides a cooling fluid flow, comprising:
a wall separating the hot gas flow from the cooling fluid flow and having a hot surface along which the hot gas flows and a cool surface facing the cooling fluid flow;
at least one film-hole having an inlet on the cool surface and an outlet on the hot surface with a passage extending from the inlet to the outlet;
a coating bound by a radius of curvature and applied to at least a portion of the passage including the outlet and extending beyond the outlet along the hot surface; and
a diffusing section defined by the passage and the coating and having an increasing cross-sectional area extending at least to the outlet.

14. The airfoil of claim 13 wherein the increasing cross-sectional area is continuously increasing.

15. The airfoil of claim 13 wherein the at least one film-hole further includes a laid back section having an increasing cross-sectional area where the coating is provided in a portion of the laid back section to define the diffusing section.

16. The airfoil of claim 13 wherein the film-hole comprises a metering section located upstream of the diffusing section.

17. The airfoil of claim 16 wherein the metering section is located in at least one of the passage or the inlet.

18. The airfoil of claim 13 wherein the diffusing section extends only partially along the passage and forms a junction at an end of the diffusing section opposite of the outlet.

19. The airfoil of claim 18 wherein the coating extends from the junction to the outlet.

20. The airfoil of claim 19 wherein the passage defines a surface line that tangentially intersects the radius of curvature at the junction.

21. The airfoil of claim 13 wherein the coating is further bound by a border line extending along the radius of curvature.

22. The airfoil of claim 13 wherein the coating has a varying thickness.

23. The airfoil of claim 13 wherein the passage includes an interior surface defined in part by the film-hole and in part by the coating.

24. The airfoil of claim 13 wherein the coating extending along the hot surface maintains a constant thickness.

25. The airfoil of claim 13 wherein the coating extending along the hot surface has a variable thickness.

26. A method of forming a film-hole for an engine component, the film-hole having an inlet along a cool surface and an outlet along a hot surface and connected by a passage extending from the inlet to the outlet, the method comprising forming a diffusing section defining the outlet and having an increasing cross-sectional area and applying a coating along a portion of the passage bound by a radius of curvature and onto the hot surface such that a portion of the diffusing section is defined by the coating.

27. The method of claim 26 further comprising forming a laid back section wherein the coating is applied to the laid back section to define the diffusing section.

28. The method of claim 26 further comprising forming a metering section extending from the inlet to the diffusing section.

29. The method of claim 26 wherein the applying the coating includes extending the coating from a junction at one end of the diffusing section towards the outlet and beyond the outlet along a hot surface of the engine component.

30. The method of claim 26 wherein the applying the coating further includes applying a coating having a varying thickness.
